(19) United States
(12) Patent Application Publication
(10) Pub. No.: US 2010/0220739 A1
(43) Pub. Date: Sep. 2, 2010

(54) Carrier Network Connection Device And Carrier Network

(76) Inventor: Kunihiro Ishiguro, Tokyo (JP)

Correspondence Address: Nixon Peabody LLP, P.O. Box 60610, Palo Alto, CA, 94306, US

(21) Appl. No.: 12/738,633

(22) PCT Filed: Oct. 16, 2008
(86) PCT No.: PCT/JP2008/068750

§ 371 Date: Apr. 16, 2010

(30) Foreign Application Priority Data
Oct. 18, 2007 (JP) 2007-271848
Aug. 5, 2008 (JP) 2008-291786

(51) Int. Cl. H04L 12/56

(52) U.S. Cl. 370/401; 370/392

(57) ABSTRACT

A network connection device connecting a pseudo wire of a layer 2 and a pseudo wire formed of a layer 3, comprising: a switching unit operating as an edge switch of a layer 2 network forming a first pseudo wire; a routing unit operating as an edge router of a layer 3 network forming a second pseudo wire; and a conversion unit which makes conversion between a frame of the layer 2 network and a packet of the layer 3 network.

### TECHNICAL FIELD

The present invention relates to a carrier backbone network connection device and a carrier backbone network.

### BACKGROUND OF THE INVENTION

MPLS (Multiprotocol Label Switching) defined in RFC3032 is widely known as an architecture to construct a carrier backbone network system. According to MPLS, a “label” having a short data length is assigned to a transfer packet, and the transfer packet is transferred between routers by referring the label for packet transferring. As a result, the router is not required to refer an IP header having a long data length, and it becomes possible to achieve a high speed routing. The label used in MPLS is assigned by exchanging routing information between MPLS routers using a protocol, such as LDP (Label Distribution Protocol). Furthermore, according to MPLS, VPN (Virtual Private Network), a hierarchical path, and etc. can be achieved by stacking a plurality of labels. Therefore, at present, MPLS is widely used in a large scale backbone network.

FIG. 1 illustrates an example of a configuration of a network system employing MPLS. The network system shown in FIG. 1 includes an MPLS domain 4 and a user network 2. The MPLS domain 4 and the user network 2 are connected via a provider edge router PE. A provider edge router PE is connected to another provider edge router PE via provider routers P in the MPLS domain 4. The transfer packet transmitted from the user network 2 is assigned a label, at the provider edge router PE, based on an IP address to which the transfer packet is to be sent, and is transferred, with the label being changed by the provider routers P.

As a method for achieving VPN in the MPLS domain 4, a method in which two types of MPLS labels are assigned to a packet transferred from the user network 2 at the provider edge router PE can be used. One of the labels assigned in the method is a label for transfer in the MPLS domain 4, and the other label is a label for VPN identification. Between the provider routers P, the packet is transferred based on the label for transfer. The VPN identification label is neither referred to nor changed by the provider routers P, and is referred to only by the provider edge router PE. The receiver side provider edge router PE identifies VPN based on the VPN label so that a pseudo wire is formed between the sender side provider edge router PE and the receiver side provider edge router PE.

Regarding the above described VPN using MPLS, a technique which is called EoMPLS (Ethernet Over MPLS) in which an Ethernet frame is capsulated by an MPLS packet is known (“Ethernet” is a trademark of Xerox Co. in U.S.). A merit that an Ethernet frame can be transmitted and received transparently can be obtained between networks connected to each other via EoMPLS. Furthermore, provider's expense for facilities can be reduced to a relatively low level because existing MPLS networks can be utilized.

As described above, by executing label stacking in a network system in which a backbone network uses a MPLS domain, a high-performance network, such as VPN, can be achieved. However, a problem arises that the stability of the network reduces because of increase of the number of headers added to an IP packet due to stacking of labels. For example, at least five headers are used in EoMPLS, and it is not preferable that more than five headers are stacked in regard to construction of the network requiring a high carrier grade of reliability. Indeed, a serious problem caused by such a complicated header structure in an MPLS network using the highly stacked headers has been reported. In addition, there is a problem that since the label of MPLS is assigned based on the IP address of a destination node, the scalability for increasing the scale of the network is limited.

To solve such problems, a wide area Ethernet technology called PBB (Provider Backbone Bridges) for constructing a backbone network using Ethernet technology is in the spotlight. PBB is used to provide VPN service in Ethernet (layer 2). FIG. 2 is an illustration showing a configuration of a network system using a PBB domain 3. The network system shown in FIG. 2 is configured by connecting a PBB domain 3 with a user network 2. The PBB domain 3 and the user network 2 are connected by a provider edge switch PES. A provider edge switch PES is connected to another provided edge switch PES connected to another user network 2 via provider switches PS.

In the PBB domain 3, an Ethernet frame (MAC frame) transmitted from the user network 2 is added a new header for PBB at the provider edge switch PES, and is transferred in the PBB domain 3. The newly added header has fields for a destination MAC address (B-MAC) and a sender MAC address (B-SA), and, to these fields, the MAC addresses of the destination and sender provider edge switches PES are inputted. Furthermore, a tag for VLAN identification, called B-TAG including B-VID which is a V-LAN identifier, and a tag for user identification, called I-TAG, are newly added as headers. Such a frame which is used in the above described PBB network and which is made by capsulating the MAC frame transferred from the user network into the MAC frame of the PBB network is referred to as a MAC-in-MAC format frame. The provider switch PS transfers the capsulated user MAC frame based on the MAC address of the provider edge switch PES. As a result, since the provider switch PS is required only to learn the MAX address of the provider edge switch PES, the effect of increase of nodes can be reduced, and excellent scalability can be achieved. Furthermore, in comparison with the case where MPLS is used, the number of headers can be decreased, and therefore excellent stability can be provided.

As a technology for realizing traffic engineering (TE) in the network system using the above described PBB, a technology called PBB-TE or PBT (Provider Backbone Transport) proposed by Nortel Co. has been developed. The network system using PBT has the similar configuration to that shown in FIG. 2. In PBT, through combination of B-VID included in B-TAG and B-DA assigned by the provider edge switch PES, a point-to-pint path, such as a label path of MPLS, can be explicitly set. As a result, it becomes possible to set a multipath using B-VID, and thereby it becomes possible to effectively use a band. Furthermore, by employing OAM (Operation, Administration and Maintenance) defined, for example, in IEEE 802.1 ag, ITU-T Y. 1731 and etc., the maintenance function in the carrier grade in the wide area Ethernet has also been realized.

As described above, PBT has the traffic engineering technology and the function of OAM which lack in the conventional wide area Ethernet, and therefore the PBT is highly appreciated as a candidate of the next generation network architecture which substitutes the MPLS network.

### DISCLOSURE OF THE INVENTION

However, since PBT is a layer 2 network configured by Ethernet switches, it is impossible to use the infrastructure of the layer 3 routers configuring the MPLS network which is an existing large scale backbone IP network. Therefore, to employ PBT, it becomes necessary to construct the layer 2 network for PBT, as a completely new network system, such as an NGN (New generation Network). Although PBT is a low cost network system configured by Ethernet switches, to replace the existing MPLS backbone networks with new PBT networks can not be accepted due to economic reasons. That is, the problem concerning scalability that the existing MPLS networks face can not be solved by PBT.

The object of the present invention is to provide a network system that improves scalability of the conventional IP backbone network, and a network connection device configuring the network system.

According to an embodiment of the invention, there is provided a network connection device connecting a pseudo wire formed on a layer 2 and a pseudo wire formed on a layer 3, comprising: a switching unit operating as an edge switch of a layer 2 network forming a first pseudo wire; a routing unit operating as an edge router of a layer 3 network forming a second pseudo wire; and a conversion unit which makes conversion between a frame of the layer 2 network and a packet of the layer 3 network.

According to the network connection device having the above described configuration, it becomes possible to connect the pseudo wire formed on the layer 3 network with the pseudo wire formed on the layer 2 network. By using such a network connection device, it becomes possible to install additionally the layer 2 network having a high degree of scalability around the periphery of the layer 3 network, and thereby to improve the scalability of the existing layer 3 network.

In this case, it is preferable that the layer 2 network is a wide area Ethernet network, and the layer 3 network is an IP network. Optionally, the IP network may be an EoMPLS network, and the wide area Ethernet network may be a PBB-TE network.

The conversion unit may be configured to make conversion between the frame of the layer 2 network and the packet of the layer 3 network by making changes between a header of a frame of the layer 2 network and a header of a packet of the layer 3 network or by adding a header of a packet of the layer 3 network to a frame of the layer 2 network.

In this case, it is preferably that a frame of the layer 2 network is a PBB-TE frame, and a packet of the layer 3 network is an EoMPLS packet, and that the conversion unit makes conversion between an I-TAG value of the PBB-TE frame and a VPN identification label of the EoMPLS packet.

Further, it is preferable that the conversion unit makes conversion between an Ethernet OAM frame of the wide area Ethernet network and an MPLS-OAM packet of the MPLS network.

According to an embodiment, there is provided a network, comprising: a layer 3 network; and a layer 2 network connected to the layer 3 network via one or more connection points, wherein the network includes a plurality of edges, and a first pseudo wire is formed between different two edges of the plurality of edges, and wherein the first pseudo wire is formed by connecting a second pseudo wire formed on the layer 2 network with a third pseudo wire formed on the layer 3 network at the one or more connection points.

According to the network having the above described configuration, since the pseudo wire formed on the layer 3 network is connected with the pseudo wire formed on the layer 2 network, it becomes possible to install additionally the layer 2 network having a high degree of scalability around the periphery of the layer 3 network, and thereby to improve the scalability of the existing layer 3 network.

In this case, it is preferable that the layer 3 network is an MPLS network and the layer 2 network is a PBB-TE network. Optionally, the layer 3 network may be an EoMPLS pseudo wire, and edges at both ends of the first pseudo wire may be provided on the PBB-TE network. Optionally, for a service requiring a high degree of availability, only the second pseudo wire may be used. In this case, the service requiring the high degree of availability is an emergency notification service.

The network may be configured to include a network connection device that connects the pseudo wires, and a network management device that collects route information of the network and makes explicit route settings, wherein the management device collects the route information and makes explicit route settings for a point-to-point, through the network connection device.

According to the network connection device and the network having the above described configuration, it becomes possible to install additionally the layer 2 network having a high degree of scalability around the periphery of the layer 3 network, and thereby to improve the scalability of the conventional IP backbone network.

### BRIEF DESCRIPTION OF THE DRAWINGS

FIG. 1 is a schematic illustration of a form of a topology of an MPLS network.

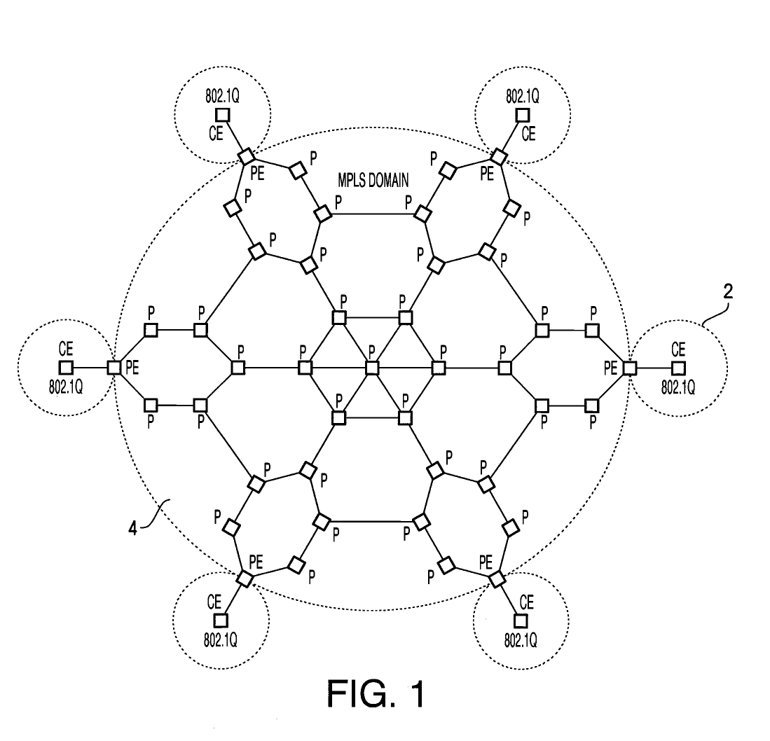

FIG. 2 is a schematic illustration of a form of a topology of a PBB network.

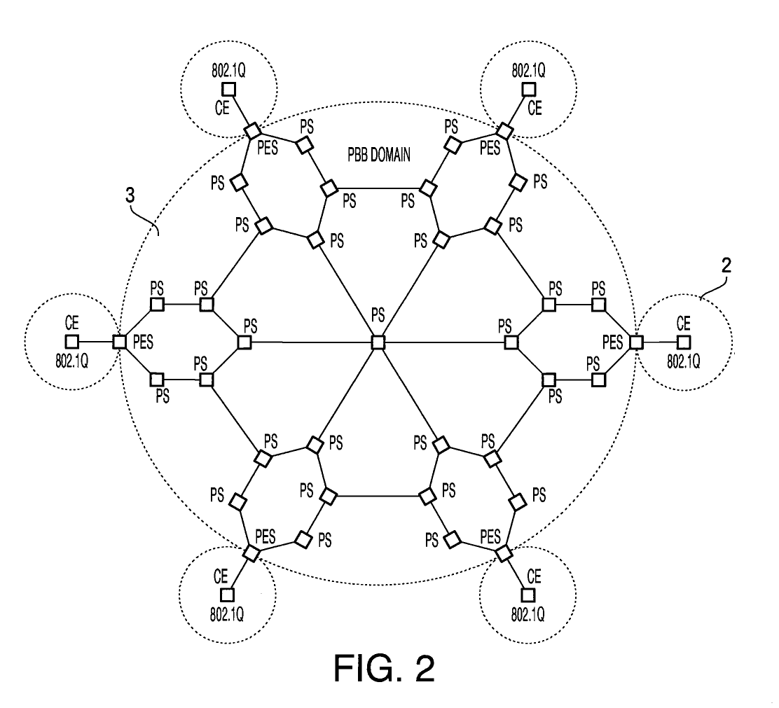

FIG. 3 is a schematic illustration of a topology of a network system according to an embodiment of the present invention.

FIG. 4 illustrates general configurations of a packet and frames used in the network system according to the embodiment of the invention.

FIG. 5 is a block diagram illustrating an internal configuration of a provider core edge PCE according to the embodiment of the invention.

FIG. 6 illustrates examples of conversion tables which the provider core edge PCE according to the embodiment of the invention has.

FIG. 7 illustrates an example of an end-to-end communication path in the network system according to the embodiment of the invention.

FIG. 8 illustrates a general configuration of a packet used in an Overlay connection.

FIG. 9 is a schematic illustration of a topology of a network system which is a variation of the invention.

### EXPLANATION OF SYMBOLS

1 network system

20 user network

30 PBT domain

40 MPLS domain

100 IP packet

200 user MAC frame

230 user MAC tag

300 PBT frame

350 PBT tag

400 MPLS packet

420 MPLS label

421 VLAN identification label

422 transfer label

500 control unit

600 PBT switching unit

700 MPLS router unit

800 data conversion unit

810 packet conversion unit

820 OAM conversion unit

900 data processing unit

CE customer edge

PB carrier relay network

PC personal computer

PCE provider core edge

PE provider edge

PS provider switch

P provider router

PR provider edge router

### BEST MODE FOR CARRYING OUT THE INVENTION

In the following, an embodiment according to the present invention is described with reference to the accompanying drawings.

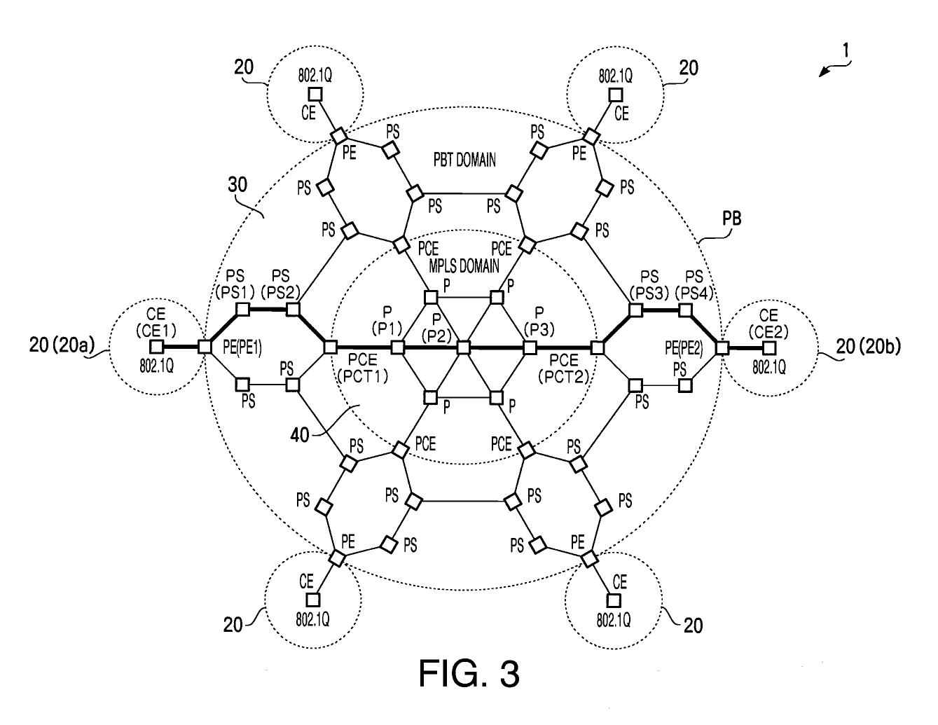

First, the entire configuration of a network system 1 according to an embodiment of the present invention is explained. FIG. 3 illustrates a topology of the network system 1. The network system 1 includes a carrier relay network PB having an MPLS domain 40 and a PBT domain 30, and a plurality of user networks 20.

The MPLS domain 40 is a single domain layer 3 network integrated by MPLS routers transferring a packet based on a label. The PBT (PBB-TE) domain 30 is a single domain layer 2 network configured by Ethernet switches complying with PBT. Further, the user network 20 is a LAN (Local Area Network) configured by nodes, such as a personal computer PC, having a network interface card (NIC) complying with IEEE 802.1Q.

The carrier relay network PB has a structure where the periphery of the MPLS domain 40 is surrounded by the PBT domain 30. That is, the user network 20 is connected only to the PBT domain 30. Further, the MPLS domain 40 is located at the core of the carrier relay network PB, and is connected to the user network 20 via the PBT domain 30. Therefore, in the network system 1 according to the embodiment, it is possible to support increase of the user networks 20 by only expanding the PBT domain 30.

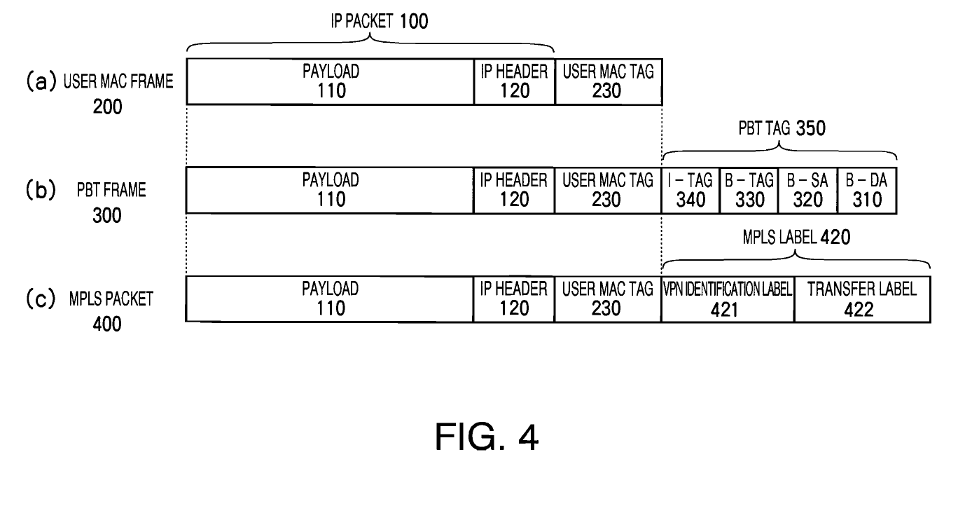

Hereafter, the concrete configuration of each domain is explained. Each node, such as a PC configuring the user network 20, has a network interface card complying with IEEE 802.1Q as described above, and executes communication by exchanging an Ethernet frame (hereafter, referred to as a “user MAC frame 200”) complying with 802.1Q. FIG. 4(a) illustrates a format of the user MAC frame 200. The user MAC frame 200 is configured such that an Ethernet header (hereafter, referred to as a “user MAC tag 230”) is added to an IP packet 100 configured by a payload 110 and an IP header 120.

The user network 20 is connected to the PBT domain 30 (i.e., a provider edge PE) of the carrier relay network PB via a customer edge CE which is an Ethernet bridge. The user MAC frame 200, which is transmitted from the PC belonging to the user network 20 and is addressed to a node (a destination PC) belonging to another user network, is transferred from the customer edge CE to the provider edge PE of the PBT domain 30.

Referring back to FIG. 3, the PBT domain 30 includes the provider edges PE, provider switches PS and provider core edges PCE which are Ethernet switches complying with three types of PBT standards. The provider edge PE is an edge switch connecting the carrier relay network PB with the user network 20, and makes conversion between the user MAC frame 200 which is exchanged in the user network 20 and a MAC-in-MAC format PBT frame 300 exchanged in the PBT domain 30.

FIG. 4(b) illustrates a format of the PBT frame 300 transferred in the PBT domain 30. The PBT frame 300 has a structure where a PBT tag 350 used for switching in the PBT domain 30 is added to the user MAC frame 200 from the user network 20. That is, the PBT frame 300 has the structure in which the user MAC frame 200 is capsulated wholly. The PBT tag 350 includes B-DA 310 in which an MAC address of a destination provider edge PE is designated, B-SA 320 indicating an MAC address of a sender provider edge PE, B-TAG 330 including B-VID for VLAN identification, and I-TAG 340 including I-SID (service instance ID) for user/service identification. In the PBT domain 30, an Ethernet pseudo wire is formed by VLAN identified based on B-VID included in B-TAG 330, and the user MAC frame 200 is transferred transparently between the edges.

The provider core edge PCE according to the embodiment is a network connection device having the function of connecting the PBT domain 30 with the MPLS domain 40. Therefore, the provider core edge PCE has the function as an edge switch of the PBT domain 30 and the function as an edge router of the MPLS domain 40 so as to serve as an interface between the PBT domain 30 and the MPLS domain 40. Specifically, at the provider core edge PCE, the PBT frame 300 exchanged in the PBT domain 30 and an after-mentioned MPLS packet 400 exchanged in the MPLS domain 40 are converted with respect to each other. The details about functions of the provider core edge PCE are explained later.

The MPLS domain 40 configuring the core of the carrier relay network PB is configured by two types of MPLS routers including the provider router P and the above described provider core edge PCE. As described above, the provider core edge PCE is a network connection device having the function as an edge router of the MPLS domain 40, and connects the PBT domain 30 with the MPLS domain 40. The provider router P is connected only to the MPLS routers configuring the MPLS domain 40. The MPLS packet 400 which has been converted at the provider core edge PCE by an after-mentioned method is transferred to the receiver side provider core edge PCE via the provider routers P.

FIG. 4(c) illustrates a format of the MPLS packet 400 transferred in the MPLS domain 40. An MPLS label 420 is configured by a transfer label 422 for transferring in the MPLS domain 40, and a VPN identification label 421 for identifying VPN. The MPLS packet 400 is configured such that the PBT tag 350 of the PBT frame 300 is replaced with the MPLS label 420. By the VPN identification label 421, a pseudo wire is formed between the edges (i.e., the provider core edges PCE) of the MPLS domain 40. Further, the MPLS packet 400 according to the embodiment is configured as an EoMPLS format MPLS packet where a label is added to the user MAC frame 200 which is an Ethernet frame. Indeed, data is transferred, on a link configuring the MPLS domain 40, as a frame to which a layer 2 tag is added further. However, since processing on the layer 2 of the MPLS network is well-known, explanations thereof are omitted.

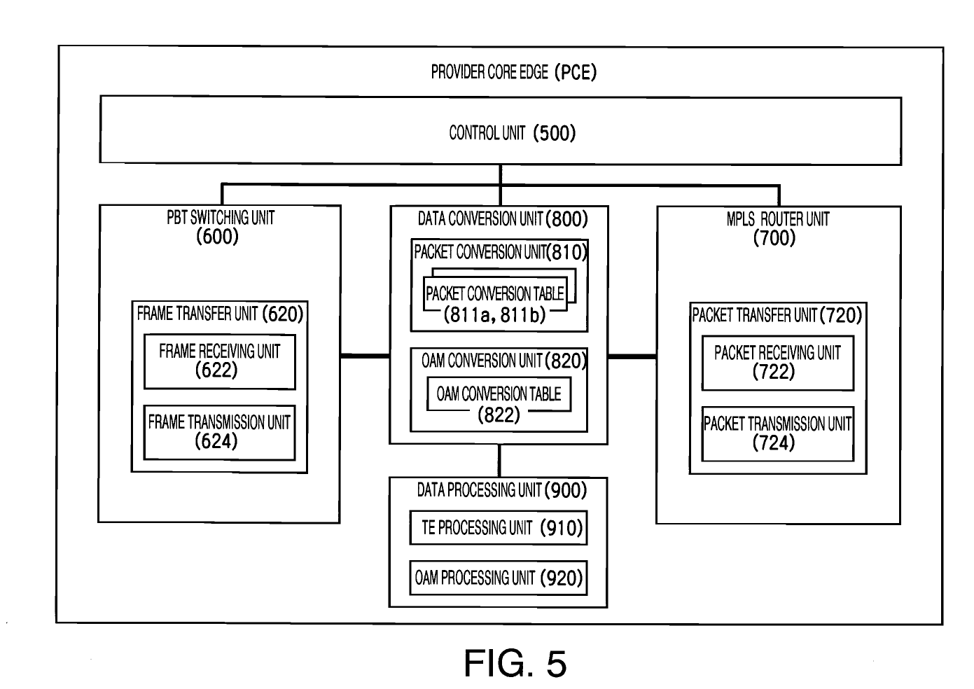

Next, the configuration of the provider core edge PCE according to the embodiment of the invention is explained. FIG. 5 is a block diagram illustrating the configuration of the provider core edge PCE. The provider core edge PCE includes a control unit 500 controlling entirely the device, a PBT switching unit 600 functioning as a PBT switch, an MPLS router unit 700 functioning as an MPLS router, a data conversion unit 800 executing data conversion for a transfer frame/packet and an OAM frame/packet, and a data processing unit 900 which executes processing for the traffic engineering (TE) and operation, administration and maintenance (OAM).

The PBT switching unit 600 includes a frame transfer unit 620 having a frame receiving unit 622 which receives the PBT frame 300 and a frame transmission unit 624 which transmits the PBT frame 300. Further, the MPLS router unit 700 includes a packet transfer unit 720 having a packet receiving unit 722 which receives the MPLS packet 400 and a packet transmission unit 724 which transmits the MPLS packet 400.

The data conversion unit 800 includes a packet conversion unit 810 which makes conversion between the PBT frame 300 and the MPLS packet 400, and an OAM conversion unit 820 which makes conversion between an Ethernet OAM frame and an MPLS-OAM packet. The OAM frame (OAM packet) is a test frame (packet) transmitted periodically to a switch (router) as a target of maintenance and administration.

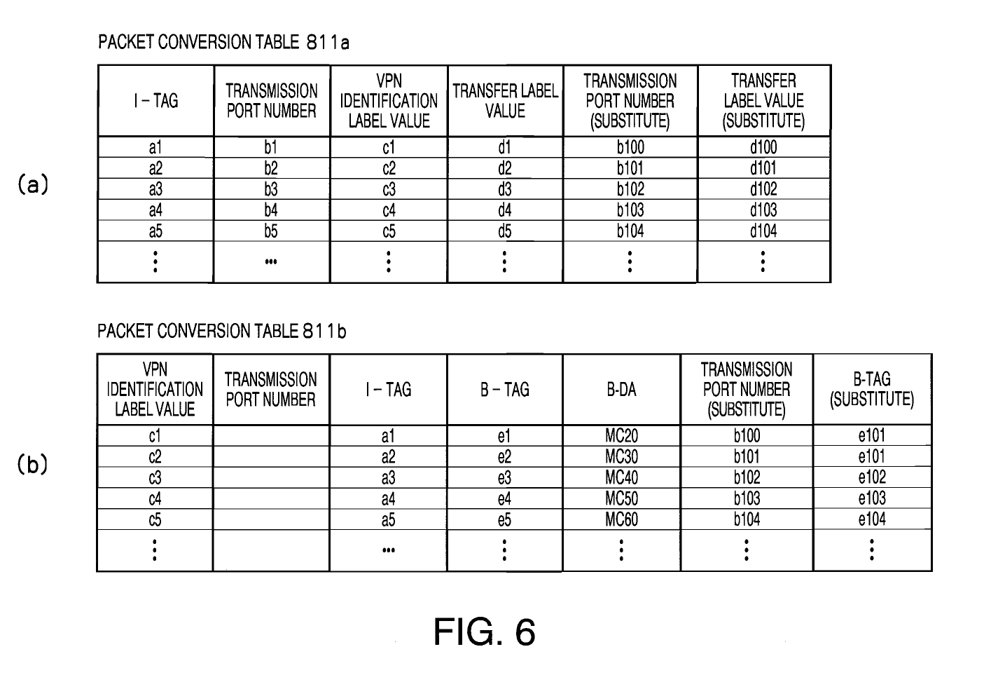

The packet conversion unit 810 has packet conversion tables 811a and 811b to be referred to when the conversion between the PBT frame 300 and the MPLS packet 400 is executed. The packet conversion tables 811a 811b are prepared respectively for each of transferring directions. FIG. 6 illustrates examples of the packet conversion tables 811a and 811b.

FIG. 6(a) illustrates the packet conversion table 811a to be referred to when the PBT frame 300 is converted to the MPLS packet 400. The packet conversion table 811a includes I-TAG (a1, a2, . . . ) of the received PBT frame 300, a transmission port number (b1, b2, . . . ) of the MPLS packet 400, the VPN identification label value (c1, c2, . . . ), and the transmission label value (d1, d2, . . . ). Furthermore, the packet conversion table 811a includes a substitute transmission port number (b100, b101, . . . ) and a substitute transfer label value (d100, d101, . . . ) indicating a substitute route. By this structure, when an OAM processing unit 920 detects a route trouble, the control unit 500 instructs the packet conversion unit 800 to execute conversion of the PBT frame 300 based on the substitute transmission port number and the substitute transfer label value.

FIG. 6(b) illustrates the packet conversion table 811b to be referred to when the MPLS packet 400 is converted to the PBT frame 300. The packet conversion table 811b includes the VPN identification label value (c1, c2, . . . ) of the MPLS packet 400 to be received, the transmission port number (b11, b12, . . . ) of the PBT frame 300 to be transmitted, and the values of the PBT tags including the I-TAG (a1, a2, . . . ), B-TAG (e1, e2, . . . ) and B-DA (MC20, MC32, . . . ). As in the case of the packet conversion table 811a, the packet conversion table 811b includes a substitute transmission port number (b100, b101, . . . ) and a substitute B-TAG 330 value (e100, e101, . . . ) indicating a substitute route to deal with a route trouble and etc. When a route trouble or etc. is detected, the control unit 500 instructs the packet conversion unit 800 to make conversion of the MPLS packet 400 based on the substitute transmission port number and the substitute B-TAG value.

Referring back to FIG. 5, the OAM conversion unit 820 makes conversion between the OAM frame based on the Ethernet OAM (e.g., ITU-T Y.1731, and IEEE802.1ag) exchanged in the PBT domain 30 and the OAM packet based on the MPLS-OAM (e.g., ITU-T Y.1711, LSP ping, and LSP traceroute) exchanged in the MPLS domain 40. The OAM conversion unit 820 has an OAM conversion table 822, and makes conversion between the Ethernet OAM frame and the MPLS-OAM packet based on the table. In the OAM conversion table 822, the Ethernet OAM frame and the MPLS-OAM packet which have the same information are associated with each other.

The data processing unit 900 has a TE processing unit 910 which executes processing regarding the traffic engineering (TE), and the OAM processing unit 920 which executes processing regarding the OAM. The TE processing unit 910 is a processing unit which executes processing necessary for the TE, such as determination of a route by combination of B-VID included in B-TAG and B-DA in the PBT domain 30, and assigning of a label by exchange of link state information in the MPLS domain 40. The information processed by the TE processing unit 910 is transmitted to the data conversion unit 800, and the data conversion unit 800 creates and updates the packet conversion tables 811a and 811b based on the information. The OAM processing unit 920 is a processing unit which executes processing, such as verification of connectivity and checking of presence/absence of a route trouble based on the received OAM frame and the OAM packet. When the OAM processing unit 920 detects a route trouble, the OAM processing unit 920 informs the control unit 500 of the route trouble so that the above described substitute route is selected.

As described above, the provider core edge PCE according to the embodiment is provided with the packet conversion unit 810 for making conversion between the MPLS packet 4000 and the PBT frame 300 in addition to the function as an edge switch in the PBT domain 30 and the function as an edge router of the MPLS domain 40. The provider core edge PCE having the above described functions makes it possible to connect the pseudo wire of the PBT frame 300 in the PBT domain 30 with the pseudo wire of the MPLS packet 400 in the MPLS domain 40. Therefore, regarding the routers and switches other than the provider core edge PCE, ordinary devices complying with PBT or EoMPLS standard can be used to construct the carrier relay network PB. As a result, an existing network system can be changed to a network system having a high degree of scalability at a low degree of extra investment.

The provider core edge PCE according to the embodiment includes the OAM conversion unit 820 which makes conversion between the OAM frame based on the Ethernet frame exchanged in the PBT domain 30 and the OAM packet based on MPLS-OAM exchanged in the MPLS domain 40. With this configuration, the operation, administration and maintenance of the entire carrier relay network PB can be centralized, and the cost and time for the maintenance can be reduced considerably, and therefore a high degree of availability can be realized at a low cost. By providing an element which executes a conversion process of OAM only for the provider core edge PCE, ordinary devices complying with PBT or EoMPLS standard can be used for nodes other than the provider core edge PCE. Therefore, an existing network system can be changed to a network system having a high degree of scalability while achieving the operation, administration and maintenance, at a low degree of extra investment.

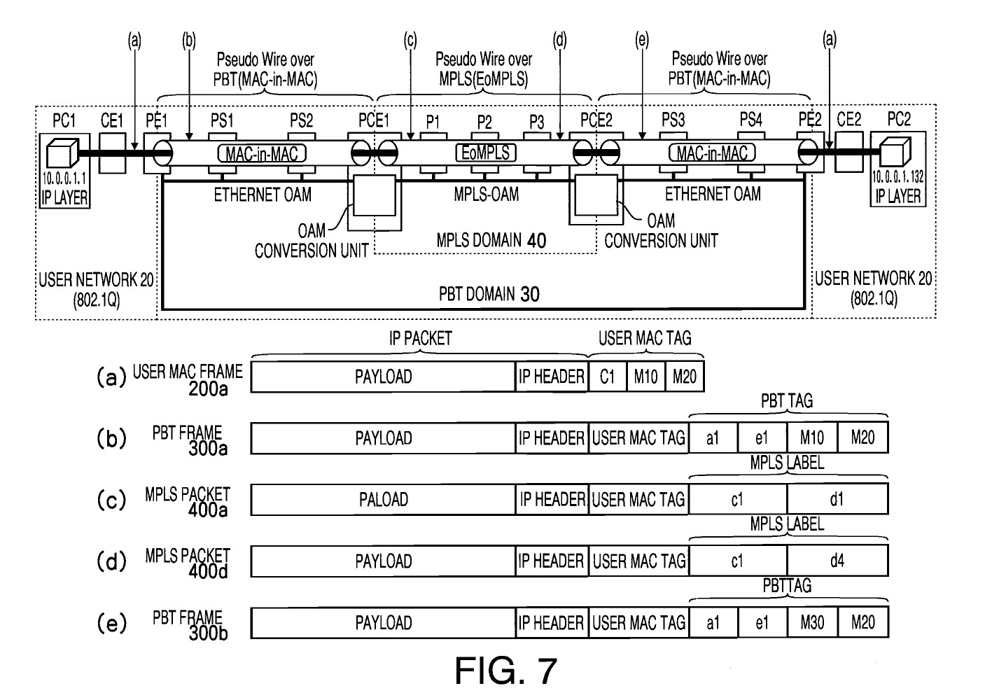

Next, an example of an end-to-end communication in the network system 1 according to the embodiment is explained with reference to FIG. 7. FIG. 7 illustrates an end-to-end communication route from a PC 1 in the user network 20a to a PC2 in the user network 20b.

Each of the user networks 20a and 20b configures the same IEEE 802.1Q VLAN. In the user network 20a, VLAN is defined by C-VID “C1” of a 802.1Q frame.

A layer 3 entity of the PC1 of the user network 20a generates an IP packet 100 having, as a destination IP address, an IP address (e.g., “10.0.0.1.132”) of the PC2 existing on the user network 20b, and passes the IP packet 100 to a layer 2 entity. The layer 2 entity of the PC1 which has received the IP packet 100 refers to the destination IP address of the IP packet 100 and a transfer table, and adds, to the IP packet, a user MAC tag 230 where the destination MAC address is defined as the MAC address “M20” of the PC2, the sender MAC address is defined as the MAC address “M10” of the PC 1, and the C-VID is defined as “C1”, and generates a user MAC frame 200a shown in FIG. 7(a) and transmits the user MAC frame 200a to the customer edge CE1.

The customer edge CE1 which has received the user MAC frame 200a refers to a transfer table to identify the transfer destination port from the destination MAC address “M20” of the user MAC frame 200a, and transfers the user MAC frame 200a to the port to which the provider edge PE1 is connected.

The provider edge PE1 which has received the user MAC frame 200a refers to a transfer table based on the value “C1” of C-VID and the destination MAC address “M20”, and converts the user MAC frame 200a to a PBT frame 300a shown in FIG. 7(b) to be transferred in the PBT domain 30. Specifically, the provider edge PE1 obtains, from the transfer table, B-TAG “e1” for VLAN identification, I-TAG “a1” for user identification, the MAC address “MC20” (B-DA) of the provide edge PE2 which is a destination node in the PBT domain 30, and the MAC address “MC10” (B-SA) of the sender provider edge PE1, and adds these pieces of information to the user MAC frame 200a. The PBT frame 300a generated on the provider edge PE1 is then transmitted to the provider switch PS1 from a predetermined port.

The provider switch PS1 which has received the PBT frame 300a refers to a transfer table, and identifies a next relay node (provider switch PS2) from the value of B-VID included in B-TAG and B-DA, and transmits the PBT frame 300a to the next relay node. The similar processing is executed on the provider switch PS2 which has received the PBT frame 300b, and the PBT frame 300a is transferred to the provider core edge PCE1. As described above, in the PBT domain 300, the user MAC frame 200 is transferred through the pseudo wire formed by VLAN identified based on the value of B-VID included in B-TAG.

When the provider core edge PCE1 receives the PBT frame 300a through the frame receiving unit 622, the provider core edge PCE1 passes the PBT frame 300a to the packet conversion unit 810 of the data conversion unit 800. The packet conversion unit 810 refers to the packet conversion table 811a shown in FIG. 6(a), and obtains a transmission port number “b1” of a next hop, the value of the VPN identification label “cl” and the value of the transfer label “d1” in the MPLS domain 40, from the value (“a1”) of I-TAG of the PBT frame 300a. Then, the packet conversion unit 810 deletes the PBT tag from the PBT frame 300a, and adds, to the PBT frame 300a, the value of the VPN identification label and the value of the transfer label obtained from the packet conversion table 811a to generate an MPLS packet 400a shown in FIG. 7(c). Then, the generated MPLS packet 400a is passed to the packet transmission unit 724, and is transferred to the next relay node, i.e., the provider router P1, from the transmission port “b1”.

The provider router P1 which has received the MPLS packet 400a refers to its own label table, and obtains a transmission port number of a next hop and a transfer label “d2” from a reception port number of the MPLS packet 400a and a transfer label “d1”. Then, the provider router P1 changes the transfer label to generate an MPLS packet 400b, and transfers the MPLS packet 400b to the next relay node, i.e., the provider router P2, from a predetermined port.

Processing similar to that of the provider router P1 is executed on each of the provider routers P2 and P3, and an MPLS packet 400d assigned a transfer label “d4” (FIG. 7(d)) is transferred to the provider core edge PGE2. As described above, in the MPLS domain 400, for transferring the MPLS packet, only the transfer label is changed, without changing the value of the VPN identification. As a result, in the MPLS domain 400, the MPLS packet is transferred through the pseudo wire formed by VPN identified based on the value of the VPN identification label.

The provider core edge PCE 2 receives the MPLS packet 400d through the packet receiving unit 720, and passes the received packet 400d to the packet conversion unit 810 of the data conversion unit 800. The packet conversion unit 810 refers to the packet conversion table 811b shown in FIG. 6(b), and obtains a transmission port number “b11” of a next link in the PBT domain, B-DA “MC20”, I-TAG “a1”, and B-TAG “e1”, from the value of the VPN identification label “c1” of the MPLS packet 400d. Then, the packet conversion unit 810 deletes the VPN identification label and the transfer label from the MPLS packet 400d, and adds, to the packet, the PBT tag including B-DA “MC20”, I-TAG “a1” and B-TAG “f1” obtained from the packet conversion table 811b and its own MAC address “MC30” to generate the PBT frame 300b shown in FIG. 7(e). Thereafter, the generated PBT frame 300b is transmitted to the frame transmission unit 624, and is transferred to the next relay node, i.e., provider switch PS3, from the transmission port “b11”.

The provider switches PS3 and PS4 execute the same processing as that executed by the provider switch PS1, and respectively transfer the PBT frame 300b to the provider switch PS4 and the provider edge PE2 from predetermined ports.

The provider edge PE2 which has received the PBT frame 300b refers to a transfer table, and identifies a transmission port number to the customer edge CE which is a next relay node, from the values of I-TAG and B-TAG of the PBT frame 300b. Then, the provider edge PE2 deletes the PBT tag from the PBT frame 300b, and transmits the user MAC frame 200a to the customer edge CE2 from a predetermined transmission port.

The customer edge CE2 which has received the user MAC frame 200a refers to a transfer table to identify a transfer port from the destination MAC address “M20” and C-VID “C1”, and transfers the user MAC frame 200b to the PC2. In response to receipt of the user MAC frame 200a, the layer 2 entity of the PC2 deletes the user MAC tag and passes the IP packet to the layer 3 entity, and finally the layer 3 entity deletes the IP packet to obtain a payload. Thus, the reception is completed.

When a test Ethernet OAM frame is transmitted from the customer edge CE1 of the user network 20a, the Ethernet OAM frame is transferred by the provider edge PE1 and the provider switches PS1 and PS2 in the PBT domain 30, and is received by the provider core edge PGE1. The provider core edge PCE2 passes the received Ethernet OAM frame to the OAM conversion unit 820 of the data conversion unit 800. The OAM conversion unit 820 refers to the OAM conversion table 822 to convert the Ethernet OAM frame to the MPLS-OAM packet, and transfers the MPLS-OAM packet to the next relay node, i.e., the provider router P1. When the MPLS-OAM packet is received by the provider core edge PCE2 after being transferred through the provider routers P1-P3 in the MPLS domain 40, the MPLS-OAM packet is converted into the Ethernet OAM frame by the OAM processing unit 820 of the provider core edge PCE 2, and the Ethernet OAM frame is transferred to the provider switch PS of the PBT domain 30.

The embodiment of the present invention have been described above; however, the scope of the invention is not limited to the above described embodiment. For example, although, in the above described embodiment, the PBT domain 30 is a single domain, the PBT domain 30 may be divided into a plurality of domains. By dividing the domain, the number of nodes in each domain can be decreased, and therefore route management in each domain becomes easier, and a further higher degree of scalability can be achieved. Furthermore, even if a serious trouble is caused in a certain domain, a risk of the ripple effect of the trouble to other domains can be decreased. Therefore, it becomes possible to construct a network having a higher degree of reliability. In this case, the domain division may be designed so that a substitute rout can be secured when a certain domain is down.

In the above described embodiment, the provider core edge PCE is configured such that the PBT domain 30 and the MPLS domain 40 are connected in the same layer (i.e., Peering). However, the present invention is not limited to such a configuration. For example, the present invention may be applied to a so-called Overlay network where the PBT domain 30 and the MPLS domain 40 are connected to each other in different layers. In the case of the Overlay network, the PBT frame 300 transferred in the PBT domain 30 is capsulated, by the provider core edge PCE, into the MPLS packet 400 transferred in the MPLS 40.

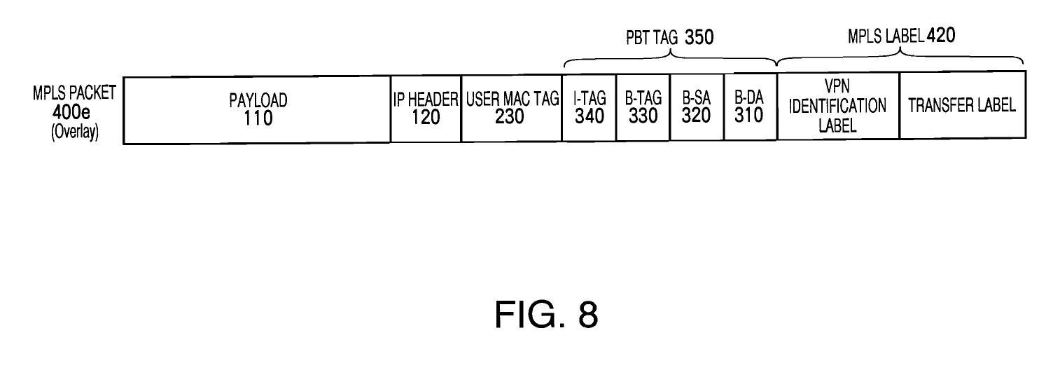

FIG. 8 illustrates an MPLS packet 400e used in this case. The MPLS packet 400e shown in FIG. 8 is generated at the packet conversion unit 810 of the provider core edge PCE by referring to the packet conversion table 811 a. Specifically, as in the case of the above described embodiment, the transmission port number of the next hop, the value of the VPN identification label and the value of the transfer label in the MPLS domain 40 are obtained from the value of I-TAG of the PBT frame 300. Then, the value of the VPN identification label and the value of the transfer label are added to the PBT frame 300 to generate the MPLS packet 400e.

Thereafter, as in the case of the above describe embodiment, the MPLS packet is transferred to the receiver side provider core edge PCE, with only the transfer label of the MPLS packet being changed at the provider routers P of the MPLS domain 40. The receiver side provider core edge PCE refers to a label table to identify a port number of a next hop from the value of the VPN identification label of the MPLS packet 400e. Then, the provider core edge PCE deletes the value of the VPN identification label and the value of the transfer label, and restores the packet to the original PBT frame 300 to transfer the original PBT frame 300 to a next relay node from a predetermined transmission port. By the above described configuration, the PBT frame 300 is transferred transparently through the pseudo wire of the MPLS domain 40. The receiver side provider core edge PCE is not required to execute the packet conversion from the MPLS packet to the PBT frame, and therefore it is not necessary to have the packet conversion table 811b. Consequently, the processing load can be reduced.

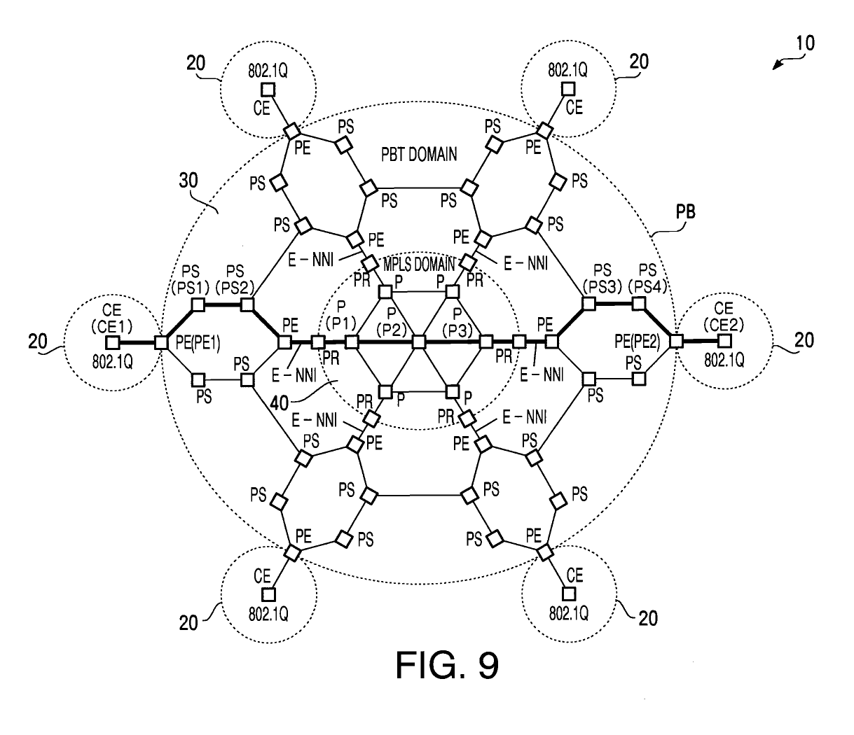

Although, in the above described embodiment, the provider core edge PCE has both of the function as the edge switch of the PBT domain 30 and the function as the edge router of the MPLS domain 40, the present invention is not limited to such a configuration. FIG. 9 illustrates a topology of a network system 10 which is a variation of the invention. As shown in FIG. 9, in the network system 10, a provider edge PE which is an edge switch of the PBT domain 30 and a provider edge router PR which is an edge router of the MPLS domain 40 are connected by E-NNI (Ethernet Network to Network Interface) defined in IEEE 802.1ah in place of connecting the PBT domain 30 with the MPLS domain 40 through the provider core edge PCE in the above described embodiment.

In this case, the PBT frame is transferred from the provider edge PE of the PBT domain 30 to the provider edge router PR via E-NNI. In this configuration, the provider edge router PR has the function as the edge router of the MPLS domain 40, the packet conversion function of making conversion between the MPLS packet 400 and the PBT frame 300, and the OAM conversion function. Explanations of these functions are omitted since these functions are the same as those of the packet conversion unit 810 and the OAM conversion unit 820 of the provider core edge PCE.

With this configuration, by only providing the packet conversion function for making conversion between the MPLS packet 400 and the PBT frame 300 for the provider edge router PR, the present invention can be realized by only utilizing the existing edge switch and the interface (E-NNI) in the PBT domain 30. Therefore, it becomes possible to connect the PBT domain 30 with the MPLS domain 40 by only making slight modifications to the existing network system.

In the above described embodiment, the packet entering into the carrier relay network PB from the provider edge PE1 takes such a route that the packet passes once the MPLS domain 40, after passing though the PBT domain 30, and exits the carrier relay network PB from the provider edge PE2 after passing through the PBT domain on the opposite side. However, it is not necessary to pass along the PBT domain-MPLS domain-PBT domain route, and a route passing only the PBT domain 30 and outgoing from the carrier relay network PB can be set. Furthermore, there is a case where a route of entering and outgoing a plurality of times between the PBT domain 30 and the MPLS domain 40 is advantageous, and such a route may be employed. In the above described embodiment, all the provider edges PE are provided on the PBT domain 30. However, a part of the provide edges PE may be arranged on the MPLS domain 40. In this case, a route of entering from a provider edge PE on the MPLS domain 40 and exiting from another provider edge PE on the MPLS domain 40 or from another provider edge PE on the PBT domain 30 may be employed.

By making comparison of communication reliability between the MPLS domain 40 and the PBT domain 30, it is understood that the PBT domain 30 where communication is performed only in the layer 2 has an extremely higher degree of reliability than that of the MPLS domain 40. Therefore, it is desirable that the routing is set to pass only the PBT domain for services requiring a high degree of reliability, such as an emergency call.

Although, in the above described embodiment, the data processing unit for controlling TE and OEM is provided for the provider core edge PCE, the present invention is not limited to such a configuration. For example, a network management system (NMS) for making control for TE and OAM of the entire carrier relay network PB (not shown) may be provided in the network system 1. In this case, by connecting the provider core edge PCE to NMS, it becomes possible to create and update the packet conversion tables 811a and 811b or to choose a substitute transfer destination based on the information concerning TE and OAM from NMS. Furthermore, in the above described embodiment, the packet conversion tables 811a and 811b are created and updated based on the information processed by the TE processing unit 910. However, the packet conversion tables 811a and 811b may be created and updated in accordance with a manual operation by an operator.

1. A network connection device for connecting a pseudo wire formed on a layer 2 and a pseudo wire formed on a layer 3, the device comprising:
a switching unit configured as an edge switch of a layer 2 network forming a first pseudo wire;
a routing unit configured as an edge router of a layer 3 network forming a second pseudo wire; and
a conversion unit configured to make conversion between a frame of the layer 2 network and a packet of the layer 3 network.

2. The network connection device according to claim 1, wherein the layer 2 network is a wide area Ethernet network, and the layer 3 network is an IP network.

3. The network connection device according to claim 2, wherein the IP network is an MPLS network.

4. The network connection device according to claim 3, wherein the wide area Ethernet network is a PBB-TE network, and the MPLS network is an EoMPLS network.

5. The network connection device according to claim 1, wherein the conversion unit is further configured to make changes between a header of a frame of the layer 2 network and a header of a packet of the layer 3 network to make conversion between the frame of the layer 2 network and the packet of the layer 3 network.

6. The network connection device according to claim 1, wherein the conversion unit is further configured to add a header of a packet of the layer 3 network to a frame of the layer 2 network to make conversion between the frame of the layer 2 network and the packet of the layer 3 network.

7. The network connection device according to claim 4,
wherein a frame of the layer 2 network is a PBB-TE frame, and a packet of the layer 3 network is an EoMPLS packet,
wherein the conversion unit is further configured to make conversion between an I-TAG value of the PBB-TE frame and a VPN identification label of the EoMPLS packet.

8. The network connection device according to claim 3,
wherein the conversion unit is further configured to make conversion between an Ethernet OAM frame of the wide area Ethernet network and an MPLS-OAM packet of the MPLS network.

9. A network, comprising:
a layer 3 network; and
a layer 2 network connected to the layer 3 network via one or more connection points,
wherein the network includes a plurality of edges, and a first pseudo wire is formed between different two edges of the plurality of edges,
wherein the first pseudo wire is formed by connecting a second pseudo wire formed on the layer 2 network with a third pseudo wire formed on the layer 3 network at the one or more connection points.

10. The network according to claim 9,
wherein:
the layer 2 network is a PBB-TE network; and
the layer 3 network is an MPLS network.

11. The network according to claim 10, wherein the layer 3 network is an EoMPLS pseudo wire.

12. The network according to claim 10, wherein edges at both ends of the first pseudo wire are provided on the PBB-TE network.

13. The network according to claim 10, wherein, for a service requiring a high degree of availability, only the second pseudo wire is used.

14. The network according to claim 13, wherein the service requiring the high degree of availability is an emergency notification service.

15. The network according to claim 9, further comprising:
a network connection device configured to connect the pseudo wires; and
a network management device configured to collect route information of the network and make explicit route settings,
wherein the management device is configured to collect the route information and to make explicit point-to-point route settings through the network connection device.

16. The network according to claim 10, wherein a device that makes conversion between a PBB-TE frame and an MPLS packet is provided for at least one of the more than one connection points.

17. The network according to claim 10, wherein a device that makes conversion between an Ethernet OAM frame and an MPLS-OAM packet is provided for at least one of the more than one connection points.

18. The network according to claim 10, wherein the PBB-TE network is configured by a plurality of domains.
